(19) United States
(12) Patent Application Publication
(10) Pub. No.: US 2021/0264493 A1
(43) Pub. Date: Aug. 26, 2021

(54) ITEM CURATION WITH INGREDIENT-BASED LENS

(71) Applicant: Postmates LLC, San Francisco, CA (US)

(72) Inventors: Ali Haghighat Kashani, San Francisco, CA (US); Marc Greenberg, Berkeley, CA (US); Bastian Jan Michael Lehmann, San Francisco, CA (US); Sean Tracey Plaice, San Francisco, CA (US)

(21) Appl. No.: 17/250,287

(22) PCT Filed: Jun. 28, 2019
(86) PCT No.: PCT/US19/39972

§ 371 Date: Dec. 28, 2020

Related U.S. Application Data
(60) Provisional application No. 62/693,369, filed on Jul. 2, 2018.

(51) Int. Cl. G06Q 30/06; G06Q 30/02; G06F 16/9538; G06N 20/00; G06F 17/18; G06F 3/0482

(52) U.S. Cl. CPC G06Q 30/0629; G06Q 30/0201; G06F 16/9538; G06F 9/44526; G06F 17/18; G06F 3/0482; G06N 20/00

(57) ABSTRACT

Techniques described in this application are direct to facilitating curation of dish items. For example, a plurality of dish items (e.g., entre, appetizer, chicken dish, rice, drinks, etc.) may be received by a plurality of merchants that offer dish items for ordering in a network communication environment. The system can parse and analyze dish information to identify positive or negative indicators with respect to a plurality of ingredient-based lenses (e.g., only show dish items that are vegetarian, gluten-free, or spicy, or only show items based on a historical user preference, etc.). When a user selects a particular ingredient-based lens, the system can determine a subset of available dish items from the plurality of merchants by removing dish items from all available dish items. The resulting dish items that correspond with the selected ingredient-based lens can be provided to a graphical user interface (GUI) at a user device of the user.

### CROSS-REFERENCES TO RELATED APPLICATIONS

The present application is a non-provisional patent application of U.S. Patent Application No. 62/693,369, which is incorporated by reference in its entirety for all purposes.

### BACKGROUND OF THE INVENTION

When finding a suitable meal from an online restaurant menu, a vegetarian eater must search and scan to find vegetarian dish items that are vegetarian safe. While the restaurant may indicate the dietary suitability of one or two dishes on their menus, these indicators are inconsistently applied to or are incomplete in their coverage of a restaurant menu, and are likely applied differently across menus from different restaurants. Therefore, reliance on this data creates an insufficient summary of dish items with an inconsistent user experience.

### BRIEF SUMMARY OF THE INVENTION

One aspect of the present disclosure relates to systems and methods for facilitating curation of a display and selection of items. For example, the disclosure may include a computer-implemented method comprising: receiving, by an ingredient-based lens computer system, a plurality of dish items from each of a plurality of merchants, wherein each of the plurality of dish items comprises dish information that describes features of each of the plurality of dish items; maintaining, by the ingredient-based lens computer system, a plurality of local ingredient-based lenses, wherein each of the local ingredient-based lenses is associated with a plurality of indicators, wherein the plurality of indicators include one or more positive indicators and/or one or more negative indicators; for each of the plurality of dish items received from each of the plurality of merchants: parsing the dish information to identify one or more positive indicators and/or one or more negative indicators, and assigning each dish item to one or more of the plurality of local ingredient-based lenses based on the identified one or more positive indicators and/or one or more negative indicators; receiving, by the ingredient-based lens computer system, an ingredient-based lens from a consumer; comparing and matching, by the ingredient-based lens computer system, the ingredient-based lens received from the consumer with the plurality of local ingredient-based lenses; identifying, by the ingredient-based lens computer system, a subset of the plurality of dish items from one or more of the plurality of merchants based upon the comparing and matching; and providing the subset of the plurality of dish items to a graphical user interface (GUI) at a user device of the consumer.

In some examples, the local ingredient-based lenses are associated with one or more negative indicators by: determining a lens negative phrase without a lens positive prefix; and updating the one or more negative indicators based on the determination. In some examples, the local ingredient-based lenses are associated with one or more positive indicators by: determining a lens negative phrase with a lens positive prefix; and updating the one or more positive indicators based on the determination. In some examples, the plurality of local ingredient-based lenses may be incorporated in a plugin software with a browser application installed with the user device of the consumer. In some examples, the method further comprises: training a machine learning (ML) model to identify parsed terms in the dish information as a positive indicator or a negative indicator. In some examples, the ML model comprises linear regression.

Another aspect of the disclosure comprises a computer system comprising: one or more processors; and a non-transitory computer-readable medium including instructions that, when executed by the one or more processors, cause the one or more processors to: receive a plurality of dish items from each of a plurality of merchants, wherein each of the plurality of dish items comprises dish information that describes features of each of the plurality of dish items; maintain a plurality of local ingredient-based lenses, wherein each of the local ingredient-based lenses is associated with a plurality of indicators, wherein the plurality of indicators include one or more positive indicators and/or one or more negative indicators; for each of the plurality of dish items received from each of the plurality of merchants: parse the dish information to identify one or more positive indicators and/or one or more negative indicators, and assign each dish item to one or more of the plurality of local ingredient-based lenses based on the identified one or more positive indicators and/or one or more negative indicators; receive an ingredient-based lens from a consumer; compare and match the ingredient-based lens received from the consumer with the plurality of local ingredient-based lenses; identify a subset of the plurality of dish items from one or more of the plurality of merchants based upon the comparing and matching; and provide the subset of the plurality of dish items to a graphical user interface (GUI) at a user device of the consumer.

In some examples, the local ingredient-based lenses are associated with one or more negative indicators by: determining a lens negative phrase without a lens positive prefix; and updating the one or more negative indicators based on the determination. In some examples, the local ingredient-based lenses are associated with one or more positive indicators by: determining a lens negative phrase with a lens positive prefix; and updating the one or more positive indicators based on the determination. In some examples, the plurality of local ingredient-based lenses may be incorporated in a plugin software with a browser application installed with the user device of the consumer. In some examples, the instructions further cause the one or more processors to: train a machine learning (ML) model to identify parsed terms in the dish information as a positive indicator or a negative indicator. In some examples, the ML model comprises linear regression.

Another aspect of the disclosure comprises a non-transitory computer-readable storage medium storing a plurality of instructions executable by one or more processors, the plurality of instructions when executed by the one or more processors cause the one or more processors to: receive a plurality of dish items from each of a plurality of merchants, wherein each of the plurality of dish items comprises dish information that describes features of each of the plurality of dish items; maintain a plurality of local ingredient-based lenses, wherein each of the local ingredient-based lenses is associated with a plurality of indicators, wherein the plurality of indicators include one or more positive indicators and/or one or more negative indicators; for each of the plurality of dish items received from each of the plurality of merchants: parse the dish information to identify one or more positive indicators and/or one or more negative indicators, and assign each dish item to one or more of the plurality of local ingredient-based lenses based on the identified one or more positive indicators and/or one or more negative indicators; receive an ingredient-based lens from a consumer; compare and match the ingredient-based lens received from the consumer with the plurality of local ingredient-based lenses; identify a subset of the plurality of dish items from one or more of the plurality of merchants based upon the comparing and matching; and provide the subset of the plurality of dish items to a graphical user interface (GUI) at a user device of the consumer.

In some examples, the local ingredient-based lenses are associated with one or more negative indicators by: determining a lens negative phrase without a lens positive prefix; and updating the one or more negative indicators based on the determination. In some examples, the local ingredient-based lenses are associated with one or more positive indicators by: determining a lens negative phrase with a lens positive prefix; and updating the one or more positive indicators based on the determination. In some examples, the plurality of local ingredient-based lenses may be incorporated in a plugin software with a browser application installed with the user device of the consumer. In some examples, the instructions further cause the one or more processors to: train a machine learning (ML) model to identify parsed terms in the dish information as a positive indicator or a negative indicator. In some examples, the ML model comprises linear regression.

### BRIEF DESCRIPTION OF THE DRAWINGS

FIG. 1 is a block diagram illustrating an example of a lens computer system in a distributed network according to an embodiment of the disclosure.

FIG. 2 is a block diagram illustrating an example of a lens computer system in a distributed network according to an embodiment of the disclosure.

FIG. 3 is a block diagram illustrating an example of a lens computer system according to an embodiment of the disclosure.

FIG. 4 is a block diagram illustrating an example of a merchant user device according to an embodiment of the disclosure.

FIG. 5 is a block diagram illustrating an example of a consumer user device according to an embodiment of the disclosure.

FIG. 6 is a block diagram illustrating an example of a consumer user device according to an embodiment of the disclosure.

FIG. 7 is an illustrative indicators database according to an embodiment of the disclosure.

FIG. 8A is an illustrative indicators database according to an embodiment of the disclosure.

FIG. 8B is an illustrative indicators database according to an embodiment of the disclosure.

FIG. 9 is an illustrative item database according to an embodiment of the disclosure.

FIG. 10 is an illustrative item database according to an embodiment of the disclosure.

FIG. 11 is an illustrative example of a plurality of user interfaces according to an embodiment of the disclosure.

### DETAILED DESCRIPTION OF THE INVENTION

The description provided herein includes illustrative embodiments only and is not intended to limit the scope, applicability, or configuration of the disclosure. Rather, the description will provide those skilled in the art with an enabling description for implementing a preferred exemplary embodiment. It is understood that various changes can be made in the function and arrangement of elements without departing from the scope as set forth in the claims.

Embodiments of the application describe various improvements to systems, methods, and devices throughout a communication network to facilitate curation of dish items. For example, a plurality of dish items (e.g., entrée, appetizer, chicken dish, rice, drinks, etc.) may be received from a plurality of merchants that offer dish items for ordering in a distributed communication environment. The dish items may comprise dish item information (e.g., ingredients of the dish, preparation information, options for adjusting the dish, etc.) that describes features of each of the dish items. The system can parse and analyze the dish information to identify positive or negative indicators with respect to a plurality of ingredient-based lenses (e.g., only show dish items that are vegetarian, gluten-free, or spicy, or only show items based on a historical user preference, etc.). When a user selects a particular ingredient-based lens, the system can determine a subset of available dish items from the plurality of merchants or from a preselected one or more merchants by removing dish items from all available dish items. The resulting dish items that correspond with the selected ingredient-based lens can be provided to a graphical user interface (GUI) at a user device of the user.

In some embodiments, the system can train a machine learning (ML) model to correlate dish items with one or more ingredient-based lenses. For example, a user may provide feedback information for the dish item (e.g., as user feedback after ordering, or feedback from merchant users, etc.) that provides a binary classification of the dish item to one or more ingredient-based lenses (e.g., yes vegetarian, not gluten free, not spicy, etc.). The system may provide the dish information and binary classification as input to the ML model for each ingredient-based lens. The ML model may be trained to identify parsed terms in the dish information as positive and negative indicators of a correlation between the dish item and each of the ingredient-based lenses. When a confidence score of a particular ingredient-based lens exceeds a threshold accuracy level (e.g., 90%, 95%, 98%, etc.), the particular ingredient-based lens may be provided to the GUI at the user device of the user.

In some examples, the default classification of the dish item may be assigned for each dish item (e.g., default vegetarian, etc.). By providing the dish information to the trained ML model, the default classification of the dish item may be changed to a different classification of the dish item, based on the positive and negative indicators.

As a sample illustration, a merchant provides a plurality of dish items that the merchant offers for ordering. The plurality of dish items includes at least a “bowl of fried rice” as an available dish item, as well as a list of ingredients as including white rice, scrambled eggs, and soy sauce. The system can provide the dish name and list of ingredients to the ML model to determine a proper binary classification for a first ingredient-based lens (e.g., vegetarian, not vegetarian). For example, “white rice” may correspond with a positive indicator for the “vegetarian” ingredient-based lens, “scrambled eggs” may correspond with a positive indicator for the “vegetarian” ingredient-based lens, and “soy sauce” may correspond with a positive indicator for the “vegetarian” ingredient-based lens. However, when the system provides the dish name and list of ingredients to a second ML model to determine a proper binary classification for a second ingredient-based lens (e.g., vegan, not vegan), the “scrambled eggs” may correspond with a negative indicator for the “vegan” ingredient-based lens. As such, the bowl of fried rice may correspond with the first ingredient-based lens (e.g., vegetarian) and not the second ingredient-based lens (e.g., vegan). When these ingredient-based lenses are provided for selection, activation of the first ingredient-based lens may include the “bowl of fried rice” as an available dish item and activation of the second ingredient-based lens may remove the “bowl of fried rice” as an available dish item.

Various technical improvements to conventional systems are identified by the disclosure. For example, conventional systems may rely solely on information from a merchant that provides the dish item to describe the dish item. The information may be incomplete or inconsistent with respect to binary classification of ingredient-based lenses. In some examples, the information may be provided in a menu form with the expectation that a particular ingredient in a dish item will alert the user that the dish item is not vegetarian, not spicy, not vegan, and the like. Some embodiments of the improved system may analyze the dish items consistently for a plurality of ingredient-based lenses, as well as incorporate feedback from users to further provide binary classifications of these dish items for a plurality of ingredient-based lenses.

Additionally, the dish information may be received from multiple data streams, including a merchant user, consumer user that orders items, consumer user that provides feedback for items, and the like. By relying on multiple data streams, the data may be available for other purposes and reused, including descriptions of dish items at the merchant location. Inconsistencies between the data streams may be identified to improve data accuracy for the improved ingredient-based lens system.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will be described in more detail below in the following specification, claims, and accompanying drawings.

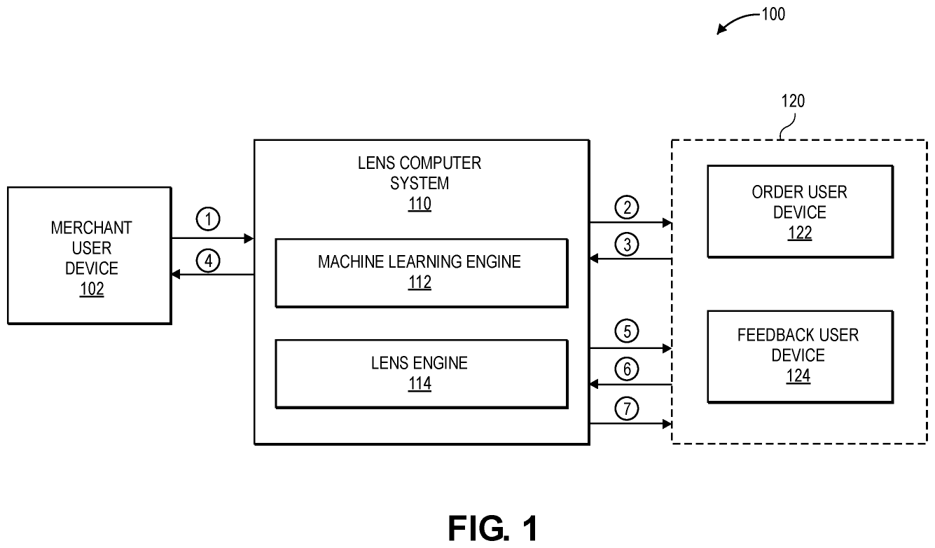

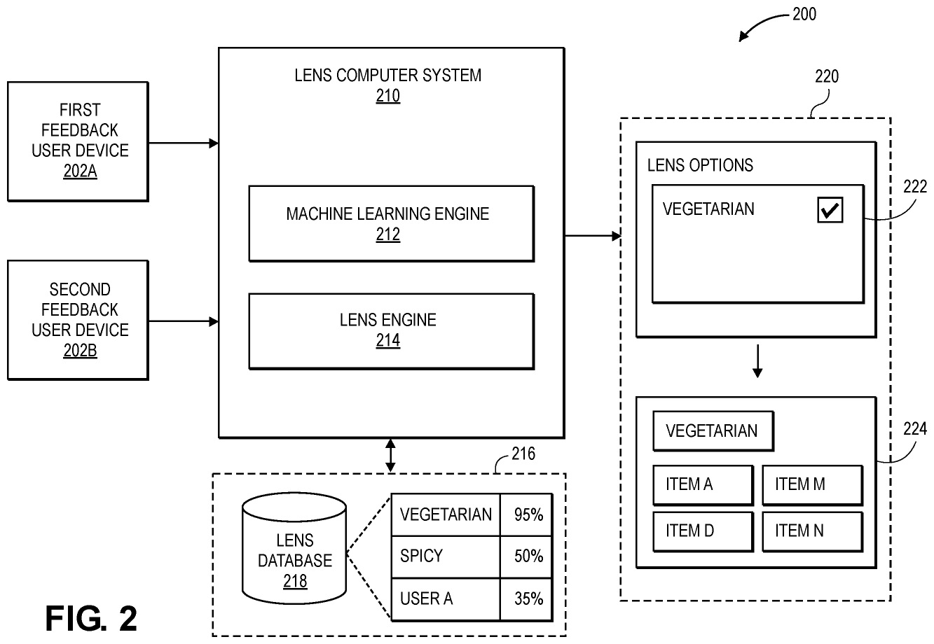

FIGS. 1-2 are a block diagrams illustrating an example of systems and devices in a distributed network according to an embodiment of the disclosure.

In illustration 100 of FIG. 1, one or more merchant user devices 102, lens computer system 110 (used interchangeably with “ingredient-based lens computer system”), and one or more consumer user devices 120 can communicate in a distributed communication network. Consumer user device 120 may comprise a single user device (e.g., by combining an order user device 122 and feedback user device 124) or separate user devices, without diverting from the essence of the disclosure. In some examples, systems and devices illustrated herein may comprise a mixture of physical and cloud computing components. Each of these systems and devices may transmit electronic messages via a communication network, either synchronously or asynchronously. Names of these and other computing devices are provided for illustrative purposes and should not limit implementations of the disclosure.

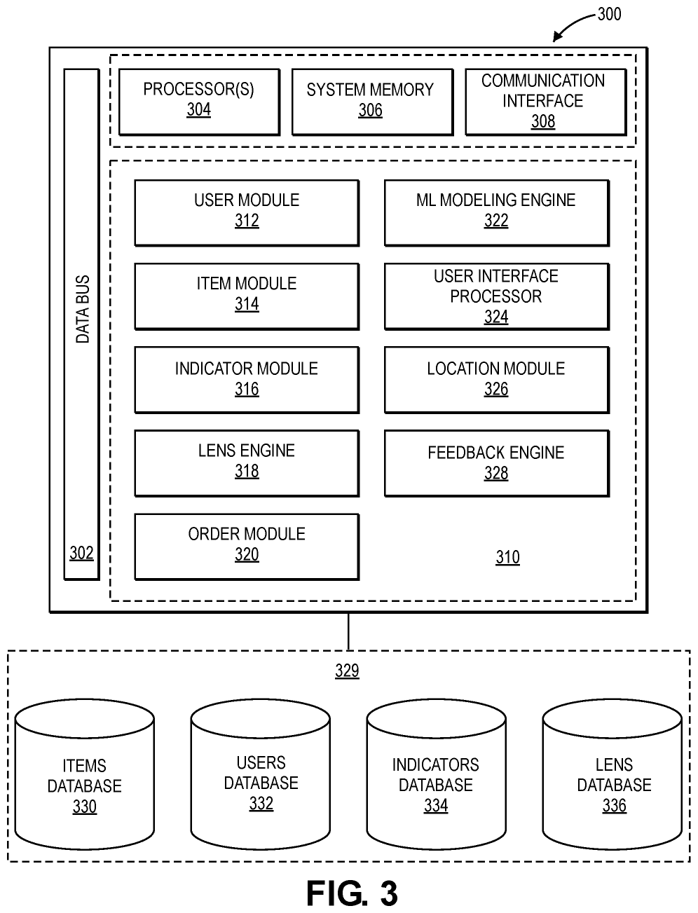

Lens computer system 110 may implement various aspects of curating dish items. Lens computer system 110 may include one or more databases to store data to implement functionality described herein. Various embodiments of lens computer system 110 are available without diverting from the essence of the disclosure. An exemplary lens computer system is illustrated in FIG. 3.

FIG. 3 is a block diagram illustrating a lens computer system according to an embodiment of the disclosure. For example, lens computer system 300 may comprise hardware and software components to facilitate curation of a plurality of dish items in a distributed network. The illustration of lens computer system 300 of FIG. 3 may be in addition to or an alternative of the illustration of lens computer system 110 of FIG. 1.

Lens computer system 300 may correspond with any number of computing devices or servers on a distributed network, including one or more processors 304 that communicate with a number of peripheral subsystems via data bus 302. These peripheral subsystems may include a system memory 306, communication interface 308, computer readable storage medium 310, and/or one or more databases 329.

Data bus 302 provides a mechanism for allowing the various components and subsystems of lens computer system 300 to communicate with each other. Although data bus 302 is shown schematically as a single bus, alternative embodiments of data bus 302 may utilize multiple buses. Data bus 302 may be several types of bus structures, including a memory bus or memory controller bus, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

One or more processors 304 may control the operation of lens computer system 300 and may comprise one or more application specific integrated circuits (ASICs) or field programmable gate arrays (FPGAs). Processors 304 may include single core and/or multicore processors. The processing resources of lens computer system 300 may be organized into one or more processing units. A processing unit may include one or more processors, one or more cores from the same or different processors, a combination of cores and processors, or other combinations of cores and processors. In some embodiments, one or more processors 304 may include one or more special purpose co-processors such as graphics processors, digital signal processors (DSPs), or the like. In some embodiments, some or all of the processing units of one or more processors 304 may be implemented using customized circuits.

In some embodiments, one or more processors 304 may execute instructions stored in system memory 306 or on computer readable storage media 310. In various embodiments, one or more processors 304 may execute a variety of programs or code instructions and may maintain multiple concurrently executing programs or processes. At any given time, some or all of the program code to be executed may be resident in system memory 306 and/or on computer readable storage media 310 including potentially on one or more storage devices. Through suitable programming, one or more processors 304 may provide various functionalities described herein. In instances where lens computer system 300 is executing one or more virtual machines, one or more processors 304 may be allocated to each virtual machine.

System memory 306 may store program instructions that are loadable and executable on one or more processors 304, as well as data generated during execution of programs. Depending on the configuration and type of lens computer system 300, system memory 306 may be volatile (e.g., random access memory (RAM), etc.) and/or non-volatile (e.g., read-only memory (ROM), flash memory, etc.). Lens computer system 300 may also include additional removable storage and/or non-removable storage including, but not limited to, magnetic storage, optical disks, and/or tape storage. The disk drives and associated computer-readable media may provide non-volatile storage of computer-readable instructions, data structures, program modules, and other data for lens computer system 300. In some implementations, system memory 306 may include multiple different types of memory, such as static random access memory (SRAM), dynamic random access memory (DRAM), solid-state drive (SSD), or ROM.

Lens computer system 300 may include communication interface 308. Communication interface 308 provides an interface to other computer systems and networks and may serve as an interface for receiving data from and transmitting data to other systems or user devices. For example, communication interface 308 may enable lens computer system 300 to establish a communication channel to one or more user devices via the external communication network for receiving and sending information to and from user devices.

Communication interface 308 may support both wired and/or wireless communication protocols. For example, in certain embodiments, communication interface 308 may include radio frequency (RF) transceiver components for accessing wireless voice and/or data networks. This may include using cellular telephone technology, advanced data network technology, such as 3G, 4G, 5G, EDGE (enhanced data rates for global evolution), WiFi (IEEE 802.XX family standards, or other mobile communication technologies, or any combination thereof), global positioning system (GPS) receiver components, and/or other components. In some embodiments, communication interface 308 may provide wired network connectivity (e.g., Ethernet) in addition to or instead of a wireless interface.

Communication interface 308 may receive and transmit data in various forms. For example, communication interface 308 may receive input communications in the form of structured and/or unstructured data feeds, clickstream data, geographic locations from a positioning system, and the like. For example, communication interface 308 may be configured to receive or send data feeds in real-time from user devices or other communication services such as web feeds and/or real-time updates from one or more third party information sources. The data feeds may be continuous or unbounded with no explicit end. Examples of applications that generate continuous data may include, for example, sensor data applications, location data applications, network monitoring and performance measuring tools, clickstream analysis tools, vehicular traffic monitoring, and the like.

Communication interface 308 may also be configured to communicate data from lens computer system 300 to other computer systems or networks. The data may be communicated in various different forms to one or more databases that may be in communication with one or more streaming data source computers coupled to lens computer system 300.

Lens computer system 300 may also comprise computer readable storage media 310. For example, computer storage media 310 may include system memory 306, volatile or nonvolatile memory, removable or non-removable media, implemented in any methodology or technology for storage of information such that computer readable instructions, data structures, program modules, or other data. The computer readable storage media may be non-transitory. Additional types of memory computer storage media may include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by lens computer system 300. Combinations of any of the above should also be included within the scope of computer-readable media.

Computer storage media 310 may further comprise an operating system (O/S), user module 312, item module 314, indicator module 316, lens engine 318, order module 320, ML modeling engine 322, user interface processor 324, location module 326, and/or feedback engine 328. Lens computer system 300 may receive and store data in various databases 329, including items database 330, users database 332, indicators database 334, and lens database 336. The modules and engines described herein may be software modules, hardware modules, or a combination thereof. If the modules are software modules, the modules will be embodied in a non-transitory computer readable medium and processed by processor(s) 304 with computer systems described herein.

User module 312 may be configured to identify one or more descriptors associated with a user. For example, the user interacting with lens computer system 300 may be identified as a consumer user or merchant user. The consumer user may be identified upon initiating an order for an item (e.g., implicit action to identify a user, etc.) or establishing a consumer user profile (e.g., explicit action to identify the user, etc.). The merchant user may be identified upon providing one or more items for ordering and delivery.

User module 312 may also be configured to determine a user profile associated with a consumer user (e.g., performing order or feedback operations, etc.) and/or merchant user. The user profile may include a user name, user device identifier (e.g., consumer user device, merchant user device, etc.) or a static location of the user, including a consumer location or a merchant location. In some examples, the user profile may also include data of one or more items ordered by a consumer user from a merchant user.

Item module 314 may be configured to determine item information. The item information may include an item name, item identifier, and dish item information (e.g., ingredients, preparation information, etc.). In some examples, the item may correspond with a food or perishable item that may require an expedited transportation timeline between a merchant location and a consumer location in order to maintain the freshness of the item.

Item module 314 may also be configured to identify one or more individual words through text recognition or optical character recognition (OCR) that identifies terms. The terms may be provided on a physical and/or paper file (e.g., printed menu, etc.), electronic file (e.g., image of the menu, electronic listing of available dish items, etc.), or other file transmitted in a distributed communication network. The terms may be compared and matched to a dictionary of previously known terms. The dictionary may be stored with item database 330. The dictionary may at least include terms common to dish item information (e.g., meats, vegetables, culinary terms, etc.).

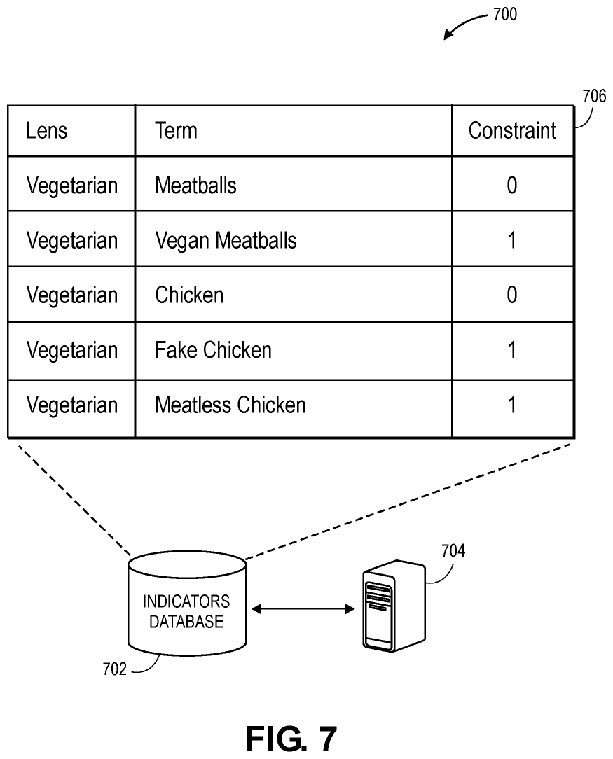

Indicator module 316 may be configured to associate the parsed terms (e.g., from item module 314) to positive or negative indicators for each ingredient-based lens. For example, term “chicken meatball” may be associated with a positive indicator for a first ingredient-based lens (e.g., chicken dishes, etc.) and term “fake chicken meatball” may be associated with a negative indicator for the first ingredient-based lens. In another example, term “chicken meatball” may be associated with a negative indicator for a second ingredient-based lens (e.g., vegetarian dishes, etc.) and term “fake chicken meatball” may be associated with a positive indicator for the second ingredient-based lens. The correlation between the term and the ingredient-based lens may be stored with the dictionary of previously known terms with the indicators database 334. An illustrative example of the indicators database is provided with FIG. 7 described further below.

The positive and negative indicators for each ingredient-based lens may be initially identified in the dictionary through various means. For example, indicator module 316 may be configured to receive a merchant user identification of all vegetarian dish items in a menu and determine common terms with the dish items associated with a particular ingredient-based lens. This may help identify terms that are commonly associated with vegetarian dish items. In another example, an administrator of lens computer system may identify common terms for the dish items associated with a particular ingredient-based lens.

Indicator module 316 may also be configured to identify positive and negative indicators of dish items regardless of a label by the merchant users. The positive and negative indicators may be stored with indicators database 334. This approach may have the advantage of being more complete than relying on a merchant user's classification, including classifying dish items not typically labelled as vegetarian, such as drinks or side dishes like rice. Individual merchant users may not need to update their menus, which could be a lengthy and incomplete process.

Indicator module 316 may also be configured to implement a classifier to determine positive and negative indicators of dish items. A simple illustration is provided for the vegetarian ingredient-based lens.

At step 1, indicator module 316 may collect all terms that constitute a dish item title and textual description in item database 330. The terms may be received from the plurality of merchant users at lens computer system and stored with item database 330.

At step 2, indicator module 316 may establish a list of vegetarian negative phrases that when present in items database 330 for a dish item, the negative phrase may designate the corresponding dish item as non-vegetarian. For example, vegetarian negative phrases may include “beef,” “chicken,” “bone in,” and the like.

At step 3, indicator module 316 may establish a list of vegetarian positive prefixes that when present immediately preceding any of the vegetarian negative phrases in items database 330, will negate the non-vegetarian description. For example, vegetarian positive prefixes may include “vegan,” “fake,” “vegetarian,” and the like. This may result in dish items containing the phrases “vegan beef” or “fake chicken” which may still be considered compliant with the vegetarian ingredient-based lens.

At step 4, a determination may be made with respect to the ingredient-based lens. For example, if none of the vegetarian negative phrases are present in the item database 330 for the dish item or if the vegetarian negative phrase is negated by a proceeding vegetarian positive prefix, the dish item may be considered compliant with the vegetarian ingredient-based lens. The vegetarian negative phrases and vegetarian positive prefixes may be stored with indicators database 334.

At step 5, the process may be repeated for any choices to configure the dish. For example, a dish item may correspond with a “Three Item Bento Box” with a required choice of three items to be included with the dish item. If the number of vegetarian dish items that are available, as defined by steps 1 through 4, does not equal or exceed the number of required choices, then the entire dish item may be considered non-compliant with the vegetarian ingredient-based lens.

A similar process comprising steps 1-5 may be implemented for additional ingredient-based lenses. For example, a second ingredient-based lens may correspond with “spicy” dish items. The process may identify spicy “negative phrases” (e.g., corresponding with step 2, including “mild,” etc.) as well as spicy “positive prefixes” (e.g., corresponding with step 3, including “hot peppers,” “Szechuan,” etc.). If none of the negative phrases are present in the items database 330 for the dish item or none of the negative phrases are negated by a preceding positive prefix, the dish item may be considered compliant for the second ingredient-based lens (e.g., corresponding with step 4). Additional descriptors are available without diverting from the scope of the disclosure.

Indicator module 316 may also be configured to determine positive and negative indicators of dish items based on a type of merchant user. For example, the merchant user may correspond with a vegan restaurant where everything from the restaurant corresponds with a vegan ingredient-based lens. The dish items provided by the merchant user may correspond with positive indicators of one or more ingredient-based lenses (e.g., vegetarian ingredient-based lens, vegan ingredient-based lens, etc.) based on the origin of the data (e.g., vegan merchant user, etc.), rather than implementing a classifier to determine positive and negative indicators of dish items.

Lens engine 318 may be configured to create a subset of a plurality of dish items that correspond with an ingredient-based lens. For example, an ingredient-based lens may correspond with positive indicators for “vegetarian.” Any dish items that correspond with terms that are associated with a negative indicator of this “vegetarian” ingredient-based lens may be removed. The removal of the dish items may generate a subset of a plurality of dish items that correspond with this ingredient-based lens. Available ingredient-based lenses may be stored with the lens database 336.

Available ingredient-based lenses may be accessed from lens database 336 and transmitted to a user interface of a user device. The available ingredient-based lenses may be installed, for example, with a plug-in at a browser associated with the consumer user device or other software application. The ingredient-based lens may be selected and applied to dish items from a single merchant or a plurality of merchants to help create a dish item level classification across menu aggregation services. The available dish items may be aggregated to provide the plurality of dish items from a plurality of merchants at a single user interface. The ingredient-based lens may show only the dishes that match its criteria, across all merchant users, menus, and pages within a menu aggregation service.

Lens engine 318 may also be configured to combine ingredient-based lenses. For example, a first ingredient-based lens may correspond with “vegetarian” and second ingredient-based lens may correspond with “spicy.” The combined ingredient-based lens may correspond with dish items that include positive indicators corresponding with “vegetarian” and “spicy” and may not include any negative indicators of these two lenses. The combined ingredient-based lens may provide a subset of dish items that include overlapping criteria that are present in dishes,

Lens engine 318 may also be configured to determine a user-specific ingredient-based lens. An order history of the consumer user may identify one or more positive or negative indicators for the ingredient-based lens, where each order in the order history complies with a particular set of positive or negative indicators. For example, the order history of the consumer may identify only dish items that correspond with “beef” positive indicators. Lens engine 318 may determine a user specific ingredient-based lens that identifies dish items that correspond with the beef positive indicator. When selected at user interface, dish items may be removed from the plurality of dish items available so that the remaining dish items may correspond with the ingredient-based lens.

Lens engine 318 may also be configured to determine a default ingredient-based lens for a consumer user device. The information may be stored with a user profile in users database 332. For example, the consumer user device may provide an identification of dietary restrictions or dish item preferences during an on-boarding process. One or more default ingredient-based lenses may be provided to the user interface of the consumer user device based on these dietary restrictions or dish item preferences. In some examples, the user profile may be updated to include an order history of ordered dish items. Classifications associated with positive and negative indicators of these dish items may be automatically stored with a default selection in the user profile without explicit user input.

Lens engine 318 may also be configured to update a consumer user preference associated with a default ingredient-based lens. For example, the consumer user may perform an explicit event, including logging into and updating a user profile that identifies the default ingredient-based lens. In some examples, the preference may be updated through an implicit event, including ordering a dish item, viewing or placing an order from a merchant user, making a reservation, tagging a favorite dish or merchant user, saving a dish or merchant user to the user profile, or planning a visit to a merchant user.

Lens engine 318 may also be configured to compare and match a received ingredient-based lens from a consumer user device with a determined ingredient-based lens stored with the lens database 336. For example, the received ingredient-based lens may be identified in a drop-down user interface tool and selected by the consumer user at the consumer user device. In some examples, the selected ingredient-based lens may be transmitted by the user interface to lens engine 318 and compared with one or more ingredient-based lenses stored with lens database 336. In other examples, the selected ingredient-based lens may be compared with one or more ingredient-based lenses stored locally with the consumer user device. Upon determining a match between the received ingredient-based lens and the stored ingredient-based lens, a subset of the plurality of dishes may be provided to user interface of the consumer user device by removing dish items from the plurality of dish items available, based on the comparing and matching.

Order module 320 may be configured to receive an order notification of a dish item. For example, the consumer user device may initiate an order for an item and the browser plug-in or other software application at the consumer user device may generate an order notification for the dish item. The order notification may comprise an item identifier associated with the merchant user and the consumer user. The order notification may request a physical transportation of the item from the merchant location to the consumer location.

Order module 320 may also be configured to transmit the order notification of one or more dish items to merchant user device after the ingredient-based lens removes items pursuant to the ingredient-based lens selection at the user interface. The transmission of the order notification to the merchant user may initiate preparation of the dish item and/or delivery of the dish item to the consumer user.

ML modeling engine 322 may be configured to apply a set of inputs to a trained machine learning (ML) model. The set of inputs may correspond with the binary classification of dish item information, title or name of the dish item, or other information associated with the classification of the dish item with respect to an ingredient-based lens. Output of the ingredient-based lens may identify a confidence score correlating the likelihood that the dish item corresponds with the ingredient-based lens.

Various ML models are available. The ML model may correspond with a linear or nonlinear function. For example, the ML model may comprise a supervised learning algorithm including a decision tree that accepts the one or more input features associated with the dish item information to determine the confidence score. When a nonlinear machine learning model is used, the weightings of fields corresponding with the dish item information may vary according to the positive and negative indicators.

In some examples, the ML model may correspond with a neural network that measures the relationship between a dependent variable (e.g., corresponding with one or more ingredient-based lenses, etc. and independent variables (e.g., the dish item information, etc.). For example, the relationship may be identified by using multiple layers of processing elements to ascertain the nonlinear relationships and interactions between the independent variables and the dependent variables. In other examples, the ML model may correspond with a Deep Learning Neural Network consisting of more than one layer of processing elements between an input layer and an output layer, or an unsupervised learning method such as K-nearest neighbors to classify inputs based on observed similarities among multivariate distribution densities of independent variables. In some examples, the ML model may comprise linear regression that can model the relationship between the dependent variable (e.g., corresponding with one or more ingredient-based lenses, etc.) and independent variable (e.g., the dish item information, etc.).

ML modeling engine 322 may also train an ML model to correlate dish items with one or more ingredient-based lenses. For example, a user may provide feedback information for the dish item (e.g., as user feedback after ordering, or feedback from merchant users, etc.) that provides a binary classification of the dish item to one or more ingredient-based lenses (e.g., yes vegetarian, not gluten free, not spicy, etc.). ML modeling engine 322 may be configured to provide the dish information and binary classification as input to the ML model for each ingredient-based lens. The ML model may be trained to identify parsed terms in the dish information as positive and negative indicators of a correlation between the dish item and each of the ingredient-based lenses. When a confidence score of a particular ingredient-based lens exceeds a threshold accuracy level (e.g., 90%, 95%, 98%, etc.), the particular ingredient-based lens may be provided to the GUI at the user device of the user.

User interface processor 324 may be configured to remove items from a plurality of dish items based on comparing a definition of an ingredient-based lens with a selected ingredient-based lens at the user interface of the consumer user device. For example, the ingredient-based lens may correspond with any dish item that does not include a negative indicator of the ingredient-based lens (e.g., “chicken” is a negative indicator of the “vegetarian” ingredient-based lens without a positive prefix including “fake” prior to “chicken,” etc.

Location module 326 may be configured to identify a location of the user. For example, the location of the user may be static, as identified in a consumer or merchant user profile. In some examples, location module 326 may receive a location of a user device from a positioning system. The positioning system may communicate with the user device to trilaterate the position of the user device based on an intersection point of overlapping spheres determined by positioning system satellites and user device positioning system receiver. Location module 326 may receive the location of the user device in a locator notification from the user device.

In some examples, locations of a plurality of merchant users may be filtered based at least in part on the location of the consumer user device. The user interface may provide a plurality of dish items from the filtered merchant users, so that only dish items from merchant user locations within a threshold distance of the consumer user location are available at the user interface in addition to filtering individual dish items according to one or more ingredient based lenses.

Feedback engine 328 may be configured to receive one or more electronic communications from consumer or merchant user devices. The electronic communication may identify false positive vegetarian dish items or questionable dish items for review to be integrated back to the items database 330. The dish item identified with the electronic communication may be provided with steps 2 or 3 of indicator module 316 to continually improve results. The identification of the dish item may be relevant at a merchant user menu level, at a more widely relevant level across a plurality of merchant users, or specifically relevant to a particular dish item.

Feedback engine 328 may also be configured to provide one or more inputs to the ML modeling engine 322. For example, the classified dishes may be used as ground truth labels so that each ingredient-based lens associated with an ML model may improve the intrinsic relationship between terms, phrases, and ingredients to create a more accurate and generalized dish item classification model. The feedback may also be used to update positive or negative indicators in association with indicator module 316.

Feedback engine 328 may also be configured to update the confidence score of the particular ingredient-based lens. For example, when the feedback identifies a false positive with respect to the dish item that correlated to ingredient-based lens, the confidence score may be decreased by a predetermined value (e.g., by 5%, by an average of other feedback received for the dish item, etc.). When the decreased confidence score is less than a threshold accuracy level (e.g., 90%, 95%, 98%, etc.), the ingredient-based lens may be removed from the user interface until the confidence score is increased to exceed the threshold accuracy level (e.g., based on additional feedback, based on administrative actions, based on additional training of the ML model, etc.).

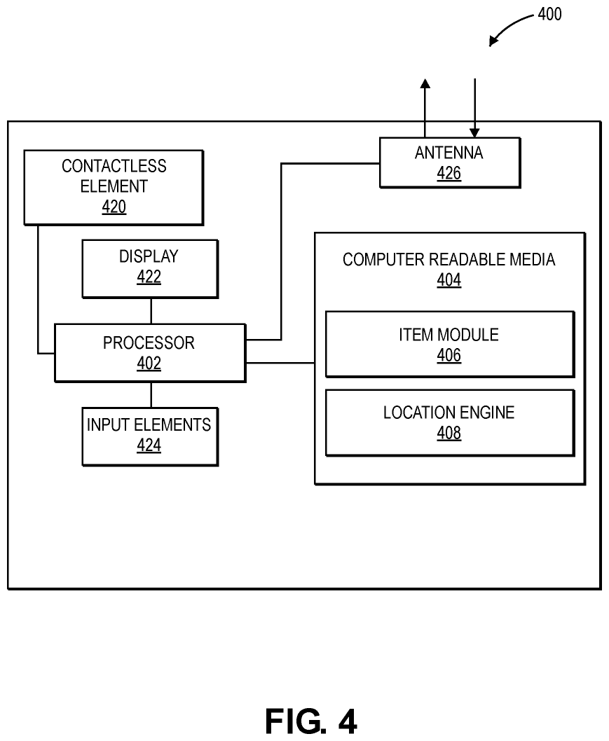

Returning to FIG. 1, lens computer system 110 communicates with merchant user device 102. Merchant user device 102 may correspond with various aspects of providing a plurality of dish items for ordering. Lens computer system 110 may receive the listing of the plurality of dish items from merchant user device 102 and combine the plurality of dish items from merchant user device 102 with one or more other merchant user devices to create a combined plurality of dish items from multiple merchant user devices. An illustrative example of merchant user device 102 is provided with FIG. 4.

FIG. 4 is a block diagram illustrating an example of merchant user device according to an embodiment of the disclosure. For example, merchant user device 400 may comprise hardware and software components. Merchant user device 400 may take any specialized form and/or including a mobile phone, PDA, tablet computer, laptop computer, handheld specialized device, etc. Merchant user device 400 may comprise processor 402, computer readable medium 404 including one or more engines or modules used to execute computer instructions, display 432, input elements 434, antenna 436, and contactless element 430.

Processor 402 may perform processing functions for merchant user device 400 by communicating with each subsystem and to control execution of computer instructions from computer readable media 404. The computer readable media 404 may be non-transitory. Merchant user device 400 may also include display 432 to allow merchant user to see information and electronic communications via a user interface. Input elements 434 may allow the merchant user to provide information to merchant user device 400, including providing one or more items available to order. Merchant user device 400 may also include antenna 436 for wireless data transfer and transmissions. Contactless element 430 of merchant user device 400 may be capable of transferring and receiving near field communications in accordance with standardized protocol or data transfer mechanisms (e.g., ISO 14443/NFC).

Computer readable media 404 may be in the form of a memory, where one or more modules or engines may be embodied in computer readable media 404, including item module 406 and location engine 408.

Item module 406 may be configured to provide item information associated with one or more dish items available for ordering from the merchant user. The item information may be displayed a network page associated with the merchant user. In some examples, the consumer user device may access the network page associated with the merchant user (e.g., provided by lens computer system 110, etc.) and identify one or more items to order from the merchant user. The item information may be transmitted to lens computer system by an electronic communication associated with consumer user device.

Item module 406 may also be configured to provide dish item information for a plurality of dish items available from the merchant user for ordering. For example, the dish item information may include ingredients of the dish item (e.g., chicken, rice, green onions, etc.), preparation information (e.g., oil, salt, pepper, etc.), options for adjusting the dish item (e.g., additional spice, substitute chicken for tofu, etc.), and the like.

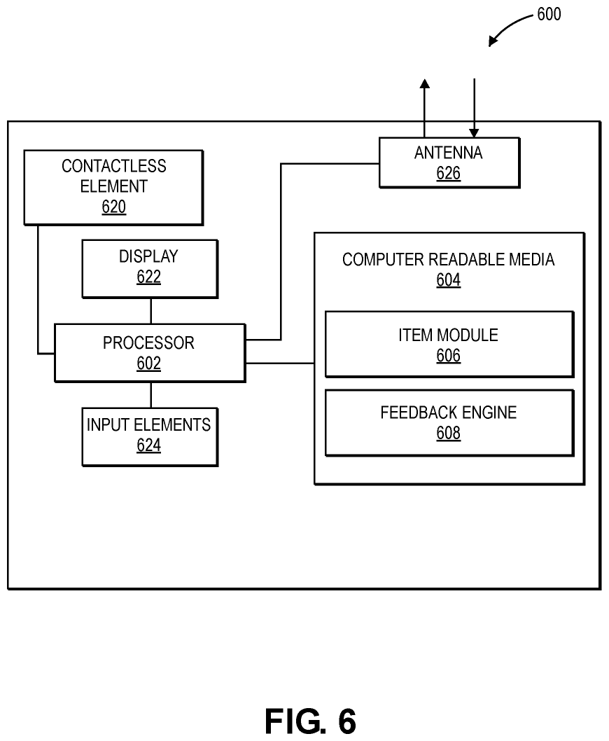

Item module 406 may also be configured to receive dish item information. For example, item module 406 may receive feedback information for one or more dish items available from the merchant user (e.g., from lens computer system illustrated in FIG. 3, or feedback user device illustrated in FIG. 6, etc.). Lens computer system 110 may provide dish item information as feedback to merchant user to update dish item information stored with merchant user device (e.g., to update a restaurant menu provided by the merchant user outside of a menu aggregation website, etc.).

Location engine 408 may be configured to identify a location of a merchant user. For example, the merchant user may identify a restaurant location as the location of the merchant user. The location of the merchant user may be used to help filter available merchant users within a threshold distance of consumer user. In some examples, only merchant user locations within the threshold distance of the consumer user may be identified with respect to the plurality of dish items available for ordering by the consumer user.

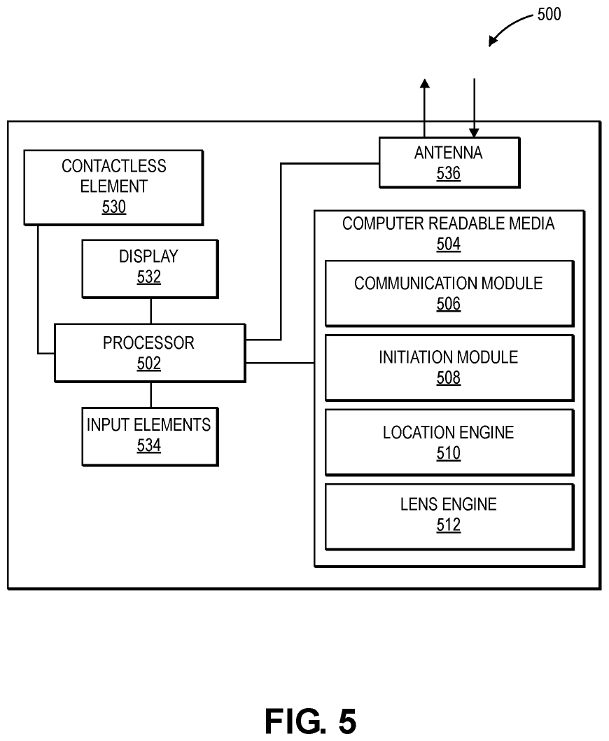

Returning to FIG. 1, illustration 100 also comprises one or more consumer user devices 120, including ordering user device 122 and feedback user device 124. Consumer user device 120 may comprise a single user device (e.g., illustrated as combined order user device 122 and feedback user device 124) or separate user devices, without diverting from the essence of the disclosure. Separate user devices are illustrated in FIGS. 5 and 6 but may be combined in other embodiments of the disclosure.

FIG. 5 is a block diagram illustrating an example of consumer user device according to an embodiment of the disclosure. For example, consumer user device 500 may comprise hardware and software components to facilitate ordering of an item from a merchant user and delivery of the item to a consumer location. Consumer user device 500 may take any specialized form and/or including a mobile phone, PDA, tablet computer, laptop computer, handheld specialized device, etc. Consumer user device 500 may comprise processor 502, computer readable medium 504 including one or more engines or modules used to execute computer instructions, display 532, input elements 534, antenna 536, and contactless element 530.

Processor 502 may perform processing functions for consumer user device 500 by communicating with each subsystem and to control execution of computer instructions from computer readable media 504. Computer readable media 504 may be non-transitory. Consumer user device 500 may also include display 532 to allow consumer user to see information and electronic communications via a user interface. Input elements 534 may allow the consumer user to provide information to consumer user device 500, including viewing and/or accepting one or more items to order from a merchant user by interacting with input elements 334. Consumer user device 500 may also include antenna 536 for wireless data transfer and transmissions. Contactless element 530 of consumer user device 500 may be capable of transferring and receiving near field communications in accordance with standardized protocol or data transfer mechanisms (e.g., ISO 14443/NFC).

Computer readable media 504 may be in the form of a memory, where one or more modules or engines may be embodied in computer readable media 504, including communication module 506, initiation module 508, location engine 510, and lens engine 512.

Communication module 506 may be configured to receive and transmit electronic messages from other computers and devices, including lens computer system 110 illustrated in FIG. 1. For example, communication module 506 may be configured to receive a list of the items available to order from a merchant location and provide a selection of one or more items to order. For example, the electronic communication may be transmitted to an application programming interface (API) associated with lens computer system 110.

Initiation module 508 may be configured to initiate an order of an item by generating an order notification of the item. For example, initiation module 508 may provide contents to populate a network page associated with a merchant user at display 532. The network page may include one or more items available for ordering from the merchant user. The consumer user may activate a tool to select one or more items provided with the network page. The item(s) may be included with an order from the merchant user. The order notification associated with the item may be transmitted to lens computer system 110.

Location engine 510 may be configured to determine a location of a consumer user in association with the order notification of item. Location engine 510 may identify the consumer location at the time of receiving the order notification as a static location. In some examples, the consumer location may be identified and stored with a consumer user profile prior to receiving the order notification for the item.

Lens engine 512 may be configured to receive one or more ingredient-based lenses from lens computer system 110 and, upon selection of the one or more ingredient-based lenses, provide a subset of a plurality of dish items according to the one or more ingredient-based lenses. In some examples, consumer user device may provide a graphical user interface (GUI) that accepts the selection of the one or more ingredient-based lenses from the consumer user. Lens engine 512 may also be configured to provide selection of the items to lens computer system 110, in association with communication module 506.

FIG. 6 is a block diagram illustrating an example of consumer user device according to an embodiment of the disclosure. For example, consumer user device 600 may comprise hardware and software components to facilitate providing feedback for a dish item. Consumer user device 600 may take any specialized form and/or including a mobile phone, PDA, tablet computer, laptop computer, handheld specialized device, etc. Consumer user device 600 may comprise processor 602, computer readable medium 604 including one or more engines or modules used to execute computer instructions, display 632, input elements 634, antenna 636, and contactless element 630.

Processor 602 may perform processing functions for consumer user device 600 by communicating with each subsystem and to control execution of computer instructions from computer readable media 604. Computer readable media 604 may be non-transitory. Consumer user device 600 may also include display 632 to allow consumer user to see information and electronic communications via a user interface. Input elements 634 may allow the consumer user to provide information to consumer user device 600, including viewing and/or accepting one or more items to order from a merchant user by interacting with input elements 334. Consumer user device 600 may also include antenna 636 for wireless data transfer and transmissions. Contactless element 630 of consumer user device 600 may be capable of transferring and receiving near field communications in accordance with standardized protocol or data transfer mechanisms (e.g., ISO 14443/NFC).

Computer readable media 604 may be in the form of a memory, where one or more modules or engines may be embodied in computer readable media 604, including item module 606 and feedback engine 608.

Item module 606 may be configured to identify one or more dish items in order. For example, consumer user device 120 (illustrated as order user device 122) may provide an identification of one or more dish items to lens computer system 110. Consumer user device 120 (illustrated as feedback user device 124) may provide feedback information associated with the one or more dish items that were ordered.

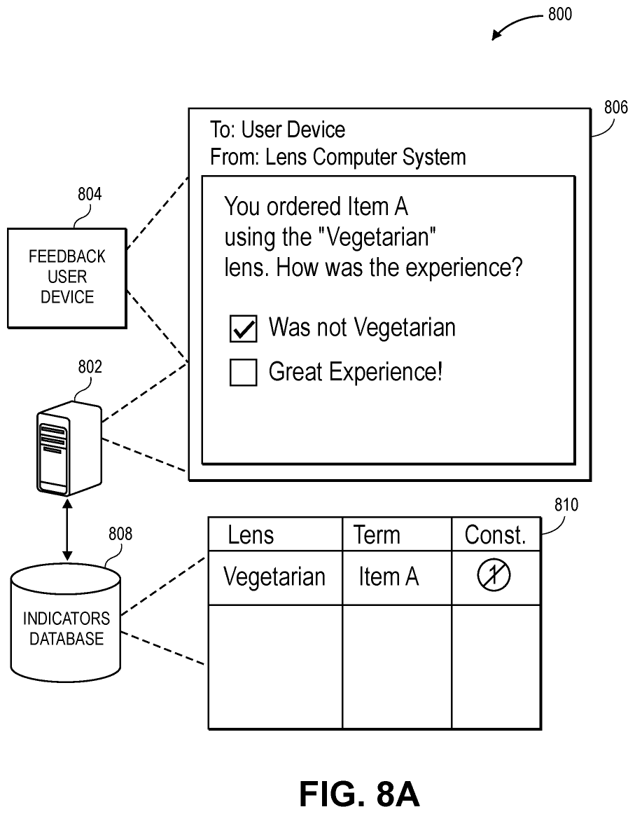

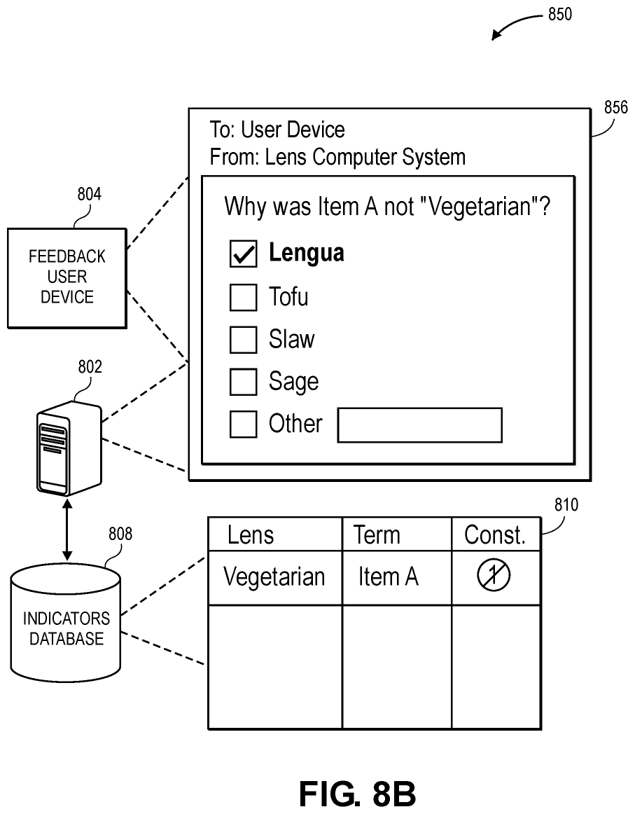

Feedback module 608 may be configured to receive an electronic communication from lens computer system 110 and provide feedback in response to the electronic communication. The electronic communication may comprise one or more questions associated with the correlation between the ingredient-based lens and the dish item provided to the consumer user. An illustrative example of this communication is provided with FIG. 8.

Returning to FIG. 1, merchant user device 102, lens computer system 110, and one or more consumer user devices 120 can communicate in a distributed communication network. In illustration 100, a plurality of systems and devices may facilitate curation of the dish items.

At step 1 of FIG. 1, merchant user device 102 may transmit a plurality of dish items to lens computer system 110. For example, merchant user device 102 may determine one or more dish items available for ordering. The dish items may comprise dish item information that describes the features of each of the dish items available from the merchant user. The dish item information may include a name of a dish item (e.g., “The Sandwich,” “chicken tortellini,” “vegan meatballs,” etc.), ingredients included in the dish item (e.g., meats, vegetables, onion, etc.), ingredients used for the preparation of the dish item (e.g., oil, salt, etc.), corresponding merchant information (e.g., vegan restaurant, Hawaiian BBQ, etc.), and the like. In some examples, the dish item information may include options available to alter the dish item, including a desired spice level, side items available, meat options, and the like.

Lens computer system 110 may receive an electronic communication identifying the plurality of dish items from merchant user device 102. The electronic communication corresponding with the plurality of dish items may include the dish item information. Lens computer system 110 may identify one or more individual terms in the electronic communication through text recognition or optical character recognition (OCR) that identifies the terms. The terms may be provided on a physical and/or paper file (e.g., printed menu, etc.), electronic file (e.g., image of the menu, electronic listing of available dish items, etc.), or other file transmitted in a communication medium. The terms may be compared and matched to a dictionary of previously known terms. The dictionary may be stored with item database 330. The dictionary may at least include terms common to dish item information (e.g., meats, vegetables, culinary terms, etc.).

Lens computer system 110 may receive additional electronic communications of a dish item information associated with a plurality of dish items from other merchant user devices as well. A plurality of merchants may provide a plurality of dish item information to lens computer system 110. A similar analysis process may be implemented for each of the plurality of dish items from the plurality of merchant user devices.

Lens computer system 110 may also receive a plurality of ingredient-based lenses from a lens database 336 of lens computer system 110. Each of the ingredient-based lenses correspond with a plurality of indicators (e.g., positive indicators, negative indicators, etc.) and may be assigned by lens computer system 110 based at least in part on the dish item information of each dish item to correlate the features of the dish item with one or more ingredient-based lens. For example, lens computer system 110 may parse the dish item information to identify one or more features of the dish item, determine a positive indicator corresponding with a first feature of the dish item, determine a negative indicator corresponding with a second feature of the dish item, and assign the dish item to one or more ingredient-based lenses based on the determination of the positive and negative indicators. The ingredient-based lenses may be determined by lens computer system 110 and previously stored with the lens database 336, as described with FIG. 3.

At step 2, lens computer system 110 may access lens database 336 to receive one or more ingredient-based lenses and provide the ingredient-based lenses as well as one or more dish items to a user interface of consumer user device 120. Consumer user device 120 may review the plurality of dish items to determine one or more dish items for ordering.

When reviewing the plurality of dish items, the one or more ingredient-based lenses may be activated to curate the available dish items for the user. Upon activation of an ingredient-based lens, the ingredient-based lens may determine a subset of a plurality of dish items that correspond with the activated ingredient-based lens. For example, when the ingredient-based lens corresponds with vegetarian dishes, the ingredient-based lens may determine a subset of the plurality of dish items that correspond with vegetarian dishes. At least some of the plurality of dish items may be removed that do not correspond with the ingredient-based lens. In some examples, all dish items that do not correspond with the ingredient-based lens are removed. The activation of the ingredient-based lens may also update the user interface to only show the dish items that correspond with the ingredient-based lens. In some examples, the ingredient-based lens may be incorporated with plugin software that may be incorporated with a browser application installed with consumer user device 120.

Upon activation of the ingredient-based lens, consumer user device 120 may select a dish item that is visible upon activation of the ingredient-based lens. Consumer user device 120 may receive a selection of dish items that have not been removed in accordance with the ingredients-based lens.

At step 3, the selection of the dish item may be transmitted to lens computer system 110. The selection of the dish item may be transmitted in an electronic communication to lens computer system 110. The electronic communication may comprise dish item information corresponding with the dish item.

Lens computer system 110 may receive the electronic communication through various methods. For example, the electronic communication may be received via an application programming interface (API) that is accessible by the browser application of consumer user device 120. Lens computer system 110 may match an item identifier associated with the electronic communication with an item identifier in the item database. Additional information associated with the dish item may be received from the item database without receiving the information in the electronic communication from consumer user device 120.

At step 4, lens computer system 110 may transmit an identification of the dish item to merchant user device 102. The identification of the dish item may be transmitted based on dish identifiers or database records. In some examples, lens computer system 110 may contact the merchant user (e.g., via electronic communication, telephonic communication, etc.) and place an order using dish item identifiers.

In some examples, lens computer system 110 may be integrated with a merchant user device. For example, lens computer system 110 may access and update merchant user device database records directly to identify a new order of one or more dish items.

Merchant user device 102 may prepare the dish item and notify lens computer system 110 that the dish item is ready. Lens computer system 110 may access the dish item from the merchant user and deliver the dish item to consumer user device 120.

At step 5, lens computer system 110 may transmit an electronic communication to consumer user device 120 to request feedback in association with the dish item. The electronic communication may comprise one or more questions to help further train a machine learning (ML) model to identify the positive and negative indicators corresponding with the ingredient-based lens. For example, the electronic communication may include “was this dish vegetarian” or “was the dish gluten-free?”

At step 6, consumer user device 120 may provide the feedback. In some examples, the feedback may comprise a binary classification of the dish item (e.g., vegetarian or not vegetarian, gluten-free or not gluten-free, etc.). Consumer user device 120 may identify the feedback based on one or more input features that are selected at the user interface of consumer user device 120. The feedback may be stored with existing feedback about the dish item.

Lens computer system 110 may parse the feedback and incorporate the binary classification of the dish item with one or more ML models that were incorporated with the training of each ingredient-based lens. For example, the consumer user may select a vegetarian ingredient-based lens and order a dish item in accordance with the vegetarian ingredient-based lens. The consumer user may identify the dish item as not vegetarian in the feedback and, in response, a confidence value associated with the vegetarian ingredient-based lens may be lowered. In some examples, the dish item information corresponding with the incorrect vegetarian dish item may be provided with training the ML model to identify the positive and negative indicators associated with the dish item information (e.g., to help improve the ML model, etc.).

At step 7, a revised ingredient-based lens may be transmitted to consumer user device 120. The revised ingredient-based lens may incorporate the updated and trained ML model in accordance with the feedback from consumer user device 120.

FIG. 2 is a block diagram illustrating an example of a lens computer system in a distributed network according to an embodiment of the disclosure. In illustration 200, a machine learning (ML) model may be trained based on feedback from one or more feedback user devices 202 (illustrated as first feedback user device 202A and second feedback user device 202B). In some examples, feedback user device 202 in FIG. 2 may correspond with consumer user device 120 in FIG. 1 and lens computer system 210 in FIG. 2 may correspond with lens computer system 110 in FIG. 1.

Lens computer system 210 may receive feedback information from one or more feedback user devices 202 and apply the feedback information for a variety of purposes. For example, the feedback information may be applied as a set of inputs to a trained ML model in association with machine learning engine 212. The output of the trained ML model may identify a confidence score correlating the likelihood that the dish item associated with the feedback information corresponds with the ingredient-based lens. In some examples, the feedback information may be applied to update one or more ingredient-based lenses in association with lens engine 214. The output of lens engine 214 may generate an updated ingredient-based lens that may be provided to a user interface for selection by a consumer user for ordering one or more items from a merchant user device.

In some examples, confidence score 216 may be adjusted in association with the feedback information. For example, the feedback information may correspond with an order identifier, dish item identifier, a particular ingredient-based lens, or other relevant information. The feedback information may identify an incorrect correlation of a binary classification of the dish item with particular ingredient-based lens (e.g., consumer user selected a vegetarian ingredient-based lens but ordered and received a dish item that was not vegetarian, etc.).

Upon identification of the incorrect correlation from one or more feedback user devices 202, the corresponding ingredient-based lens may be identified and the confidence score 216 of that ingredient-based lens may be decreased by a predetermined value (e.g., 5%, or an average of the feedback received for the ingredient-based lens, etc.). When the decreased confidence score is less than the threshold accuracy level (e.g., 90%, 95%, 98%, etc.), the ingredient-based lens may be removed from the user interface until the confidence score is increased to exceed the threshold accuracy level (e.g., based on additional feedback, based on administrative actions, based on additional training of the ML model, etc.). The ingredient-based lenses and corresponding confidence scores may be stored with lens database 218.

The ingredient-based lenses corresponding with confidence scores that exceed the threshold accuracy level may be provided to a user interface 220. The user interface may include one or more ingredient-based lenses 222 that are selectable based on an interaction at the consumer user device.

Upon selection of the ingredient-based lens, one or more dish items 224 may be provided to the user interface. The dish items that do not comply with the ingredient-based lens may be removed from the plurality of dish items provided to the user interface.

As shown in illustration 200, lens computer system 210 receives feedback information from one or more user devices 202. Lens computer system 210 may analyze the feedback information to determine a corresponding dish item (e.g., “item A”) associated with the feedback information as well as an ingredient-based lens (e.g., “vegetarian”). The feedback information may identify a correct correlation between the dish item and the ingredient-based lens selected by consumer user when ordering the dish item. Confidence score 216 corresponding with the ingredient-based lens may be increased to identify the correct correlation between the dish item and the ingredient-based lens. Confidence score 216 for the ingredient-based lens (e.g., “vegetarian”) may be remain the same or increased. When confidence score 216 is compared to a threshold accuracy level (e.g., 95%), lens computer system 210 may determine that confidence score 216 meets or exceeds the threshold accuracy level and may allow ingredient-based lens to be selectable at the user interface 220. When the ingredient-based lens is selected, one or more dish items 224 that comply with ingredient-based lens may be provided at user interface 220.

FIG. 7 is an illustrative indicators database according to an embodiment of the disclosure. In illustration 700, indicators database 702 may be accessible by lens computer system 704. The illustration of lens computer system 704 of FIG. 7 may be in addition to or an alternative of the illustration of lens computer system 110 of FIG. 1.

Indicators database 702 may comprise various positive and negative indicators in one or more database tables 706. An illustrative database table 706 may comprise one or more ingredient-based lenses, one or more terms, and one or more constraints associated with the lenses and terms. As shown in illustration 700, the various rows of the database table include terms associated with the vegetarian ingredient-based lens.

At row 1, the term “meatballs” may be received in dish item information from a merchant user device. The indicator module 316 of lens computer system may identify the term as a vegetarian negative phrase (e.g., meatballs) and assign the term as a negative indicator of the vegetarian ingredient-based lens. The negative indicator may be identified as a Boolean value in indicators database 702 (e.g., 0, no, etc.).

At row 2, the term “vegan meatballs” may be received in dish item information from a merchant user device. The indicator module 316 of lens computer system may identify the term as a vegetarian negative phrase (e.g., meatballs) and also including a vegetarian positive prefix (e.g., vegan) immediately preceding the vegetarian negative phrase. The combination of the negative phrase and positive prefix may be associated with a positive indicator of the vegetarian ingredient-based lens. The positive indicator may be identified as a Boolean value in indicators database 702 (e.g., 1, yes, etc.).

At row 3, the term “chicken” may be received in dish item information from a merchant user device. The indicator module 316 of lens computer system may identify the term as a vegetarian negative phrase (e.g., chicken) and assign the term as a negative indicator of the vegetarian ingredient-based lens. The negative indicator may be identified as a Boolean value in indicators database 702 (e.g., 0, no, etc.).

At row 4, the term “fake chicken” may be received in dish item information from a merchant user device. The indicator module 316 of lens computer system may identify the term as a vegetarian negative phrase (e.g., chicken) and also including a vegetarian positive prefix (e.g., fake) immediately preceding the vegetarian negative phrase. The combination of the negative phrase and positive prefix may be associated with a positive indicator of the vegetarian ingredient-based lens. The positive indicator may be identified as a Boolean value in indicators database 702. (e.g., 1, yes, etc.).

At row 5, the term “meatless chicken” may be received in dish item information from a merchant user device. The indicator module 316 of lens computer system may identify the term as a vegetarian negative phrase (e.g., chicken) and also including a vegetarian positive prefix (e.g., meatless) immediately preceding the vegetarian negative phrase. The combination of the negative phrase and positive prefix may be associated with a positive indicator of the vegetarian ingredient-based lens. The positive indicator may be identified as a Boolean value in indicators database 702 (e.g., 1, yes, etc.).

FIG. 8A is an illustrative indicators database according to an embodiment of the disclosure. In illustration 800, lens computer system 802 may receive feedback information from user device 804 in response to receiving electronic communication 806 to request the feedback information. The feedback information may be analyzed and stored with indicators database 808 and correspond with one or more positive and negative indicators 810. Lens computer system 802, user device 804, and indicator database 808 may correspond in some examples with lens computer system 110 and consumer user device 120 of FIG. 1 as well as indicators database 334 of FIG. 3, respectively.

In some examples, the electronic communication 806 may include a Boolean value associated with the correspondence between the dish item and the ingredient-based lens in an order associated with user device 804. User device 804 may receive a selection of the Boolean value to identify an improper correlation between the dish item (e.g., Item A) and the ingredient-based lens (e.g., vegetarian). Upon receiving this selection, lens computer system 802 may update indicators database 808 to identify that the positive indicator previously stored with the ingredient-based lens and dish item (e.g., “1”) is incorrect and update the positive indicator to a negative indicator (e.g., change to “0”).

FIG. 8B is an illustrative indicators database according to an embodiment of the disclosure. In illustration 850, lens computer system 802 may receive feedback information from user device 804 in response to receiving electronic communication 856 to request the feedback information. The feedback information may be analyzed and stored with indicators database 808 and correspond with one or more positive and negative indicators 810. Lens computer system 802, user device 804, and indicator database 808 may correspond in some examples with lens computer system 110 and consumer user device 120 of FIG. 1 as well as indicators database 334 of FIG. 3, respectively.

In some examples, electronic communication 856 may include specifically incorrect indicators, not just a Boolean value. For example, electronic communication 856 may include a listing of ingredients or other dish item information associated with the dish item. Each of the ingredients may correspond with a selection tool to identify a particular ingredient that does not correspond with the ingredient-based lens. User device 804 may receive a selection of one or more ingredients to identify an improper correlation between the dish item (e.g., Item A) and the ingredient-based lens (e.g., vegetarian). Upon receiving this selection, lens computer system 802 may update indicators database 808 to identify that the positive indicator previously stored with the ingredient-based lens and dish item (e.g., “1”) is incorrect, based on the selection of an ingredient in the dish item. The positive indicator may be updated to a negative indicator (e.g., change to “0”) for the particular ingredient and/or dish item information.

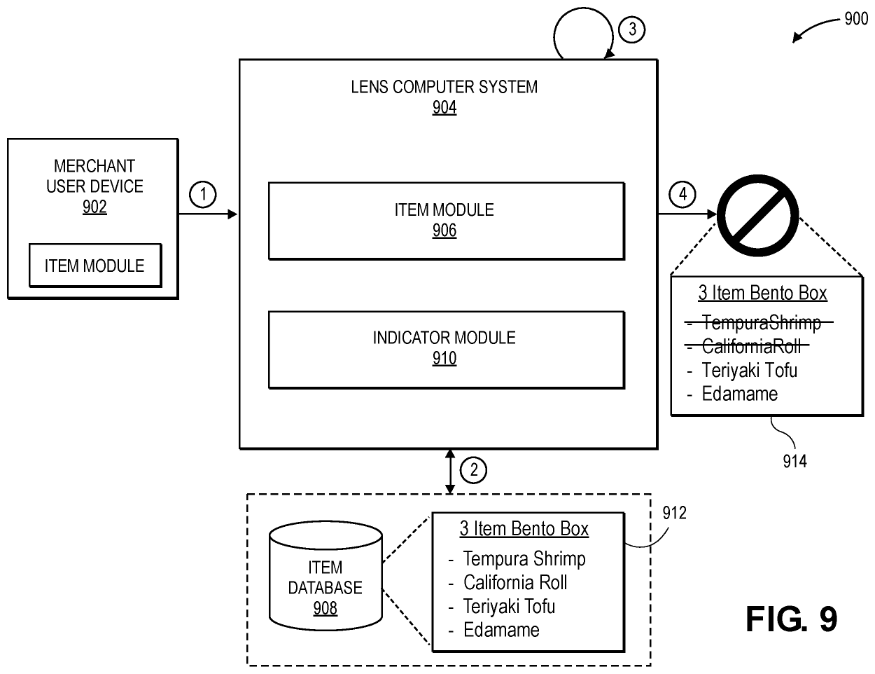

FIG. 9 is an illustrative item database according to an embodiment of the disclosure. In illustration 900, merchant user device 902 and lens computer system 904 may electronically communicate via a distributed network. In some examples, merchant user device 902 and lens computer system 904 may correspond with merchant user device 102 and lens computer system 110 of FIG. 1, respectively.

At step 1, merchant user device 902 provides a listing of a plurality of dish items lens computer system 904. The plurality of dish items may be stored with item database 908.

At step 2, item module 906 at lens computer system 904 may identify one or more individual terms through text recognition or an OCR process that identifies the terms. In some examples, the terms may be matched to a dictionary of previously known terms. Indicator module 910 at lens computer system 904 may associate the parsed terms to positive or negative indicators with each ingredient-based lens based on, for example, lens negative phrases and lens positive prefixes, as described throughout the disclosure.

As a sample illustration, the dish items 912 may include tempura shrimp, California roll, teriyaki tofu, and edamame. Lens negative phrases (e.g., for a vegetarian ingredient-based lens) may include shrimp and California roll. Lens positive prefixes (e.g., for a vegetarian ingredient-based lens), in this illustration, are not available to negate the lens negative phrases. As such, two of the items that correspond with the lens negative phrases may be removed from the plurality of dish items for the ingredient-based lens.

At step 3, lens computer system 904 may determine that a minimum number of dish items are not available for the required choice of three items (e.g., “Three Item Bento Box”) to be included with the dish item.

At step 4, lens computer system 904 may determine whether or not to provide the dish item based on the available options 914. In this example, only two items are available that correspond with the ingredient-based lens, because tempura shrimp and California roll include lens negative phrases without corresponding lens positive prefixes. Since only two dish items are available, the “Three item Bento Box” would be removed from the user interface of the user device of the user.

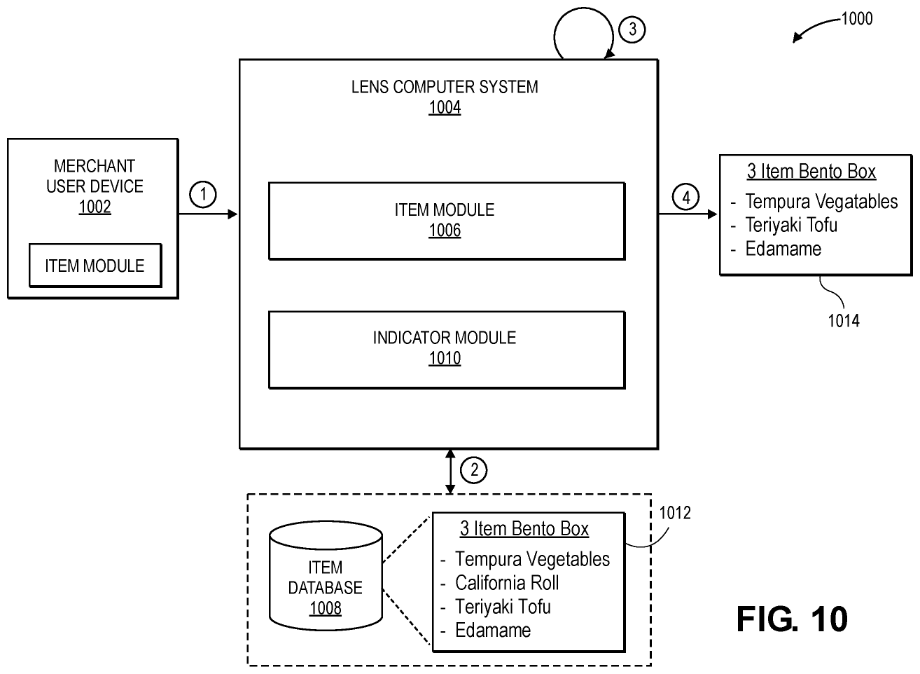

FIG. 10 is an illustrative item database according to an embodiment of the disclosure. In illustration 1000, merchant user device 1002 and lens computer system 1004 may electronically communicate via a distributed network. In some examples, merchant user device 1002 and lens computer system 1004 may correspond with merchant user device 102 and lens computer system 110 of FIG. 1, respectively.

At step 1, merchant user device 1002 provides a listing of a plurality of dish items to lens computer system 1004. The plurality of dish items may be stored with item database 1008.

At step 2, item module 1006 at lens computer system 1004 may identify one or more individual terms through text recognition or an OCR process that identifies the terms. In some examples, the terms may be matched to a dictionary of previously known terms. Indicator module 1010 at lens computer system 1004 may associate the parsed terms to positive or negative indicators with each ingredient-based lens based on, for example, lens negative phrases and lens positive prefixes as described throughout the disclosure.

As a sample illustration, the dish items 1012 may include tempura vegetables, California roll, teriyaki tofu, and edamame. Lens negative phrases (e.g., for a vegetarian ingredient-based lens) may include California roll. Lens positive prefixes (e.g., for a vegetarian ingredient-based lens), in this illustration, are not available to negate the lens negative phrases. As such, one of the items that correspond with the lens negative phrases may be removed from the plurality of dish items for the ingredient-based lens.

At step 3, lens computer system 1004 may determine that a minimum number of dish items are available for the required choice of three items to be included with the dish item.

At step 4, lens computer system 1004 may determine whether or not to provide the dish item based on the available options 1014. In this example, three items are available that correspond with the ingredient-based lens, because California roll includes lens negative phrases without corresponding lens positive prefixes. Since three dish items are available, the “Three Item Bento Box” would be available from the user interface of the user device of the user with the three dish items as available options 1014 for selection by the user device.

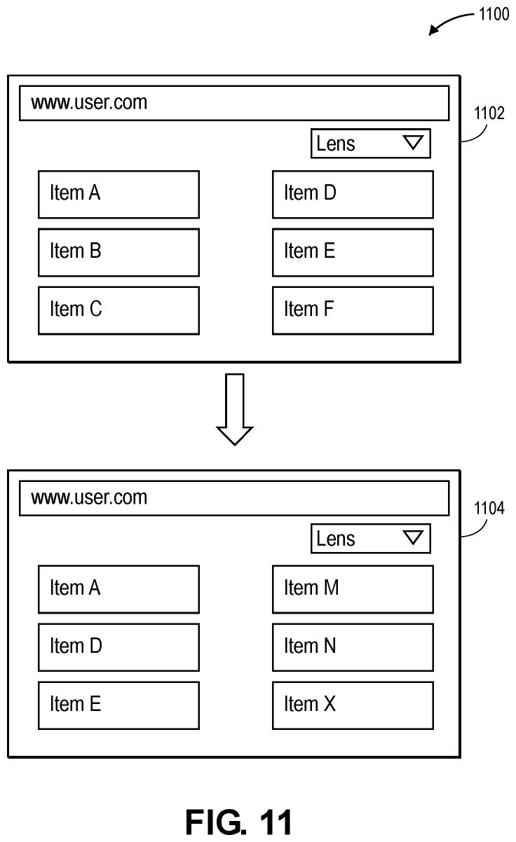

FIG. 11 is an illustrative example of a plurality of user interfaces according to an embodiment of the disclosure. In illustration 1100, first user interface 1102 provides a plurality of dish items that are available for ordering from the merchant user. Second user interface 1104 provides a subset of the plurality of dish items that are available for ordering from the merchant user. Second user interface 1104 may provide fewer dish items after a selection of an ingredient-based lens. The ingredient-based lens in second user interface 1104 may have removed one or more dish items that were originally provided with first user interface 1102.

While the principles of the disclosure have been described above in connection with specific apparatuses and methods, it is to be clearly understood that this description is made only by way of example and not as limitation on the scope of the disclosure.

1. A computer-implemented method comprising:
receiving, by an ingredient-based lens computer system, a plurality of dish items from each of a plurality of merchants, wherein each of the plurality of dish items comprises dish information that describes features of each of the plurality of dish items;
maintaining, by the ingredient-based lens computer system, a plurality of local ingredient-based lenses, wherein each of the local ingredient-based lenses is associated with a plurality of indicators, wherein the plurality of indicators include one or more positive indicators or one or more negative indicators;
for each of the plurality of dish items received from each of the plurality of merchants:
parsing the dish information to identify one or more positive indicators or one or more negative indicators, and
assigning each dish item to one or more of the plurality of local ingredient-based lenses based on the identified one or more positive indicators or one or more negative indicators;
receiving, by the ingredient-based lens computer system, an ingredient-based lens from a consumer;
comparing and matching, by the ingredient-based lens computer system, the ingredient-based lens received from the consumer with the plurality of local ingredient-based lenses;
identifying, by the ingredient-based lens computer system, a subset of the plurality of dish items from one or more of the plurality of merchants based upon the comparing and matching; and
providing the subset of the plurality of dish items to a graphical user interface (GUI) at a user device of the consumer.

2. The computer-implemented method of claim 1, wherein the local ingredient-based lenses are associated with one or more negative indicators by:
determining a lens negative phrase without a lens positive prefix; and
updating the one or more negative indicators based on the determination.

3. The computer-implemented method of claim 1, wherein the local ingredient-based lenses are associated with one or more positive indicators by:
determining a lens negative phrase with a lens positive prefix; and
updating the one or more positive indicators based on the determination.

4. The computer-implemented method of claim 1, wherein the plurality of local ingredient-based lenses may be incorporated in a plugin software with a browser application installed with the user device of the consumer.

5. The computer-implemented method of claim 1, further comprising:
training a machine learning (ML) model to identify parsed terms in the dish information as a positive indicator or a negative indicator.

6. The computer-implemented method of claim 5, wherein the ML model comprises linear regression.

7. A lens computer system comprising:
one or more processors; and
a non-transitory computer-readable medium including instructions that, when executed by the one or more processors, cause the one or more processors to:
receive a plurality of dish items from each of a plurality of merchants, wherein each of the plurality of dish items comprises dish information that describes features of each of the plurality of dish items;
maintain a plurality of local ingredient-based lenses, wherein each of the local ingredient-based lenses is associated with a plurality of indicators, wherein the plurality of indicators include one or more positive indicators or one or more negative indicators;
for each of the plurality of dish items received from each of the plurality of merchants:
parse the dish information to identify one or more positive indicators or one or more negative indicators, and
assign each dish item to one or more of the plurality of local ingredient-based lenses based on the identified one or more positive indicators or one or more negative indicators;
receive an ingredient-based lens from a consumer;
compare and match the ingredient-based lens received from the consumer with the plurality of local ingredient-based lenses;
identify a subset of the plurality of dish items from one or more of the plurality of merchants based upon the comparing and matching; and
provide the subset of the plurality of dish items to a graphical user interface (GUI) at a user device of the consumer.

8. The lens computer system of claim 7, wherein the local ingredient-based lenses are associated with one or more negative indicators by:
determining a lens negative phrase without a lens positive prefix; and
updating the one or more negative indicators based on the determination.

9. The lens computer system of claim 7, wherein the local ingredient-based lenses are associated with one or more positive indicators by:
determining a lens negative phrase with a lens positive prefix; and
updating the one or more positive indicators based on the determination.

10. The lens computer system of claim 7, wherein the plurality of local ingredient-based lenses may be incorporated in a plugin software with a browser application installed with the user device of the consumer.

11. The lens computer system of claim 7, wherein the instructions further cause the one or more processors to:
train a machine learning (ML) model to identify parsed terms in the dish information as a positive indicator or a negative indicator.

12. The lens computer system of claim 11, wherein the ML model comprises linear regression.

13. A non-transitory computer-readable storage medium storing a plurality of instructions, which when executed by one or more processors, cause the one or more processors to:
receive a plurality of dish items from each of a plurality of merchants, wherein each of the plurality of dish items comprises dish information that describes features of each of the plurality of dish items;
maintain a plurality of local ingredient-based lenses, wherein each of the local ingredient-based lenses is associated with a plurality of indicators, wherein the plurality of indicators include one or more positive indicators or one or more negative indicators;
for each of the plurality of dish items received from each of the plurality of merchants:
parse the dish information to identify one or more positive indicators or one or more negative indicators, and
assign each dish item to one or more of the plurality of local ingredient-based lenses based on the identified one or more positive indicators or one or more negative indicators;
receive an ingredient-based lens from a consumer;
compare and match the ingredient-based lens received from the consumer with the plurality of local ingredient-based lenses;
identify a subset of the plurality of dish items from one or more of the plurality of merchants based upon the comparing and matching; and
provide the subset of the plurality of dish items to a graphical user interface (GUI) at a user device of the consumer.

14. The non-transitory computer-readable storage medium of claim 13, wherein the local ingredient-based lenses are associated with one or more negative indicators by:
determining a lens negative phrase without a lens positive prefix; and
updating the one or more negative indicators based on the determination.

15. The non-transitory computer-readable storage medium of claim 13, wherein the local ingredient-based lenses are associated with one or more positive indicators by:
determining a lens negative phrase with a lens positive prefix; and
updating the one or more positive indicators based on the determination.

16. The non-transitory computer-readable storage medium of claim 13, wherein the plurality of local ingredient-based lenses may be incorporated in a plugin software with a browser application installed with the user device of the consumer.

17. The non-transitory computer-readable storage medium of claim 13, wherein the instructions further cause the one or more processors to:
train a machine learning (ML) model to identify parsed terms in the dish information as a positive indicator or a negative indicator.

18. The non-transitory computer-readable storage medium of claim 17, wherein the ML model comprises linear regression.
